(19) United States
(12) Patent Application Publication
(10) Pub. No.: US 2026/0109279 A1
(43) Pub. Date: Apr. 23, 2026

(54) ARMREST

(71) Applicants: Hyundai Motor Company, Seoul (KR); Kia Corporation, Seoul (KR); NIFCO KOREA INC., Asan-si (KR); ECOPLASTIC CORPORATION, Gyeongju-si (KR)

(72) Inventors: Min Ha LEE, Hwaseong-Si (KR); Hee Dong CHOI, Hwaseong-Si (KR); Seok Ju GIM, Hwaseong-Si (KR); Sang Woo KIM, Hwaseong-Si (KR); Mu Young KIM, Hwaseong-Si (KR); Min Sik KIM, Hwaseong-Si (KR); Hee Sang PARK, Hwaseong-Si (KR); Hyun Woo KWON, Hwaseong-Si (KR); Jong Heon LEE, Suwon-si (KR); Dong Hwan KIM, Asan-si (KR); Hae Ju PARK, Ulsan (KR)

(21) Appl. No.: 19/275,120

(22) Filed: Jul. 21, 2025

(30) Foreign Application Priority Data
Oct. 23, 2024 (KR) 10-2024-0146184

(51) Int. Cl. B60N 2/75; B60N 3/00; B60R 11/00

(52) U.S. Cl. CPC B60N 2/793; B60N 3/001; B60R 11/00; B60R 2011/0007

(57) ABSTRACT

The present disclosure provides an armrest including an armrest body having therein a storage compartment. The armrest body may include an upper surface with an opening. The armrest may further include a lid assembly that includes a flat surface configured to, in a closed position of the lid assembly, contact the upper surface of the armrest body with the flat surface facing an upper portion of the armrest body.

### CROSS-REFERENCE TO RELATED APPLICATION

This application claims priority to Korean Patent Application No. 10-2024-0146184, filed in the Korean Intellectual Property Office on Oct. 23, 2024, the entire contents of which are incorporated herein by reference.

### TECHNICAL FIELD

The present disclosure relates to an armrest in a vehicle, and more particularly, to an armrest equipped with a table.

### BACKGROUND

An armrest for a vehicle may be provided at a center of a rear seat or provided on a door so that an occupant may place his/her arm on the armrest. The armrest may sometimes be provided in a center console next to the driver seat and it may, for example, have storage components with a lid that opens and closes. An armrest may be equipped with a cup holder, a table, a charger, or the like by utilizing the storage space for extra comfort and convenience of the occupants of the vehicle.

With the continuing development of vehicles capable of autonomous driving, drivers may soon be able to perform daily tasks, such as working, resting, and even dining inside a traveling vehicle. Therefore, utilization of armrests will further increase.

### SUMMARY

The present disclosure has been made in an effort to solve problems found in at least some implementations, and an object of the present disclosure is to provide an armrest that may be provided in a vehicle and used as a table in a simple manner, as necessary, thereby improving convenience and satisfaction for a vehicle occupant.

According to one or more example embodiments of the present disclosure, an armrest of a vehicle, the armrest may include an armrest body having therein a storage compartment. The armrest body may include an upper surface with an opening. The armrest may further include a lid assembly comprising a flat surface configured to, in a closed position of the lid assembly, contact the upper surface of the armrest body with the flat surface facing an upper portion of the armrest body.

The lid assembly may further include: a hinge assembly having a first axis of rotation; and a lid having the flat surface and installed to be rotatable around a second axis of rotation. The second axis of rotation may be perpendicular to the first axis of rotation. The hinge assembly may be configured to couple the lid to one side of the armrest body.

The lid assembly may further include a coupler configured to rotatably couple the lid to the hinge assembly.

The coupler may include: a main shaft bracket having one side surface coupled to a surface of the lid, the main shaft bracket having a rotation shaft protruding from a center of the main shaft bracket; and a base bracket rotatably coupled to the main shaft bracket and coupled to the hinge assembly.

The armrest may further include: a detent configured to fix a position of the main shaft bracket at one of a plurality of predetermined rotational angles after the main shaft bracket rotates relative to the base bracket.

The detent may include a detent plate disposed between the base bracket and the hinge assembly and affixed to the rotation shaft. A plurality of detent holes may be formed on a surface of the detent plate. The detent may further include a plurality of detent balls configured to be repeatedly inserted into and withdrawn from the plurality of detent holes based on a rotation of the base bracket; and a ball holder on which the plurality of detent balls are installed at fixed positions. The ball holder may be rotatably coupled to the rotation shaft.

The plurality of detent holes formed on the surface of the detent plate may include: one or more first detent holes formed at a first distance from the second axis of rotation; and one or more second detent holes formed at a second distance from the second axis of rotation, the second distance being less than the first distance. The plurality of detent balls may be disposed at different distances from the second axis of rotation such that the plurality of detent balls are each inserted into or withdrawn from any one of the one or more first detent holes or the one or more second detent holes.

The armrest may further include at least one spring configured to exert a pressure on the ball holder against the detent plate; and a cap disposed between the at least one spring and the hinge assembly. The cap may be coupled to the ball holder to maintain the pressure exerted by the at least one spring on the ball holder. The at least one spring may be disposed between the ball holder and the cap.

The rotation shaft may include a catch at an end of the rotation shaft. The catch may have a polygonal shape having a width larger than a diameter of the rotation shaft. A fastening hole may be formed through the cap at a center of the cap. The fastening hole may have a matching cross-sectional shape as the catch. The cap may be configured to be caught by the catch based on the cap rotating by a predetermined angle after the catch passes through the fastening hole.

The armrest may further include: a stopper configured to restrict a maximum rotational angle of the main shaft bracket relative to the base bracket.

A stopper groove may be recessed on the main shaft bracket. The stopper groove may be arc-shaped and have a predetermined length. The stopper may be disposed between the main shaft bracket and the base bracket. A first surface of the stopper may be affixed to the base bracket, wherein the stopper comprises a stopper protrusion that protrudes from a second surface of the stopper and is inserted into the stopper groove, and wherein the second surface is on an opposing side, with respect to the first surface, of the stopper.

According to one or more example embodiments of the present disclosure, an armrest may include: an armrest body, wherein a top surface has an opening to a storage compartment formed inside the armrest body; a lid assembly comprising: a lid having dimensions that fit the opening of the armrest body; a hinge assembly configured to attach the lid assembly to the top surface of the armrest body such that the lid is rotatable, between a closed position of the lid and an open position of the lid, around a first axis of rotation of the hinge assembly; and a coupler that connects the hinge assembly to the lid.

The coupler may include: a first bracket, wherein a through-hole is formed through the first bracket; a second bracket coupled to the lid and comprising a shaft protruding orthogonally from a surface of the second bracket, wherein the shaft of the second bracket is inserted into the through-hole of the first bracket such that the second bracket is rotatable around a second axis of rotation that coincides with a cylindrical axis of the shaft; and a rotary detent.

The rotary detent may include a first detent disc coupled to the first bracket. A plurality of detent holes may have a first diameter. The plurality of detent holes may be formed on the first detent disc. The rotary detent may further include: a second detent disc coupled to the hinge assembly, wherein a plurality of detent ball receptacles are formed on the second detent disc; and a plurality of detent balls having a second diameter greater than the first diameter. Each of the plurality of detent balls may be inserted into a corresponding detent ball receptacle of the plurality of detent ball receptacles of the second detent disc, wherein, based on the first detent disc rotating around the second axis of rotation relative to the second detent disc, each of the plurality of detent balls is inserted into or withdrawn from one or more detent holes of the plurality of detent holes of the first detent disc. The rotary detent may be coupled to the shaft of the first bracket such that the first bracket is disposed between the second bracket and the rotary detent.

The armrest may further include: a stopper disposed between the first bracket and the second bracket and configured to restrict a maximum rotational angle of the second bracket relative to the first bracket.

The rotary detent may further include: a cap coupled to the second detent disc; and one or more springs disposed between the second detent disc and the cap. The one or more springs may be configured to exert a pressure on the second detent disc to push against the plurality of detent balls and the first detent disc.

As described above, the armrest according to the present disclosure may be provided in the vehicle and used as the table in a simple manner, as necessary, thereby improving the convenience and satisfaction for the vehicle occupant.

### BRIEF DESCRIPTION OF THE DRAWINGS

FIG. 1 is a perspective view illustrating a structure of an example armrest.

FIG. 2 is an exploded perspective view illustrating a disassembled structure of an example armrest.

FIG. 3 is an exploded perspective view illustrating a disassembled structure of a coupler of an example armrest.

FIG. 4 is a longitudinal sectional view illustrating a structure of a coupler of an example armrest.

FIG. 5 is a top plan view illustrating a structure of a detent of an example armrest.

FIGS. 6, 7, and 8 are operational views sequentially illustrating a process of restricting a rotational angle by a stopper when a coupler of an example armrest rotates.

### DETAILED DESCRIPTION

Hereinafter, an armrest according to one or more example embodiments of the present disclosure will be described in more detail with reference to the accompanying drawings.

However, the present disclosure is not limited to the example embodiments described herein and may be implemented in various different forms. One or more of the constituent elements in the one or more example embodiments may be selectively combined and substituted for use within the scope of the technical spirit of the present disclosure.

In addition, unless otherwise specifically and explicitly defined and stated, the terms (including technical and scientific terms) used in the example embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in one or more example embodiments of the present disclosure are for explaining the example embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Further, when one constituent element is described as being “connected,” “coupled,” or “attached” to another constituent element, one constituent element may be connected, coupled, or attached directly to another constituent element or connected, coupled, or attached to another constituent element through still one or more other constituent elements interposed therebetween.

In addition, the expression “one constituent element is provided or disposed above (on) or below (under) another constituent element” may include not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

Armrests for vehicles may include a console armrest (e.g., disposed between a driver seat and a passenger seat), a rear armrest foldably mounted between left and right rear seats (also referred to as a foldable armrest or a fold-down armrest) and can be collapsed into the rear seats in its stowed position, and a manual armrest rotatably mounted on a seat back of a standalone seat.

In order to improve the utility of the armrest, devices, such as a controller for manipulating a cup holder, an air conditioning device, and the like, may be mounted on the armrest. In addition, for added convenience for the passenger seated in the vehicle, a table may be foldably mounted on a rear portion of a front seat back. The table may be used, for example, by an occupant seated in the rear seat.

However, the table, in at least some implementations, mounted on the front seat back may be available only in higher-trim models of a vehicle. Further, one of the problems with some implementations of armrests is that the distance between the table and the passenger seated in the rear seat cannot be adjusted, which adversely affects the convenience of the user.

In addition, because tables in some implementations are always kept in a state of being mounted in the rear portion of the front seat back, these tables may interfere with or hinder the movement of the passenger seated in the rear seat.

In order to alleviate or solve the above-mentioned problems, a hardware component may be added to the armrest and provide a table function. However, this may increase the volume of the armrest, and the added hardware component may take up some of the interior compartment of the armrest. This may be problematic as it decreases the utilization of the internal space of the armrest, thereby negatively affecting the convenience of the armrest to the user and the design aesthetics of the armrest.

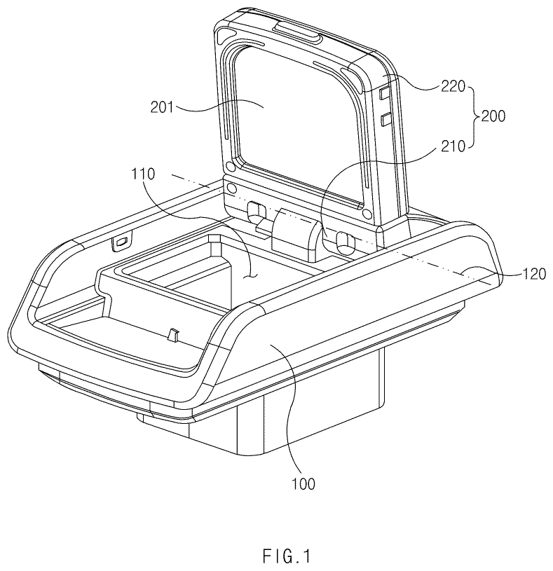

FIG. 1 is a perspective view illustrating a structure of an example armrest. As illustrated in the drawings, an armrest may be installed in a vehicle and may include an armrest body 100 having therein an accommodation space (also referred to as a storage compartment). The armrest body 100 may have an upper surface with an opening. The armrest may further include a lid assembly (also referred to as an armrest lid assembly or an armrest cover) 200 having a flat surface 201 provided on at least one of outer surfaces, of the lid assembly 200, configured to come into contact with the upper surface of the armrest body 100, the lid assembly 200 being capable of being seated (e.g., resting) on the upper surface of the armrest body 100 (e.g., in a closed position of the lid assembly 200) with the opening in a state in which the flat surface 201 is directed toward (e.g., facing) an upper portion of the armrest body.

As illustrated in FIG. 1, the armrest body 100 may refer to a member installed between seats (e.g., between the driver seat and the passenger seat) in the vehicle and configured to enable a vehicle occupant to place his/her arm thereon while driving the vehicle or being seated in the seat so that the vehicle occupant may travel while maintaining a comfortable posture. An accommodation space (also referred to as a storage compartment) 110 capable of storing various items and objects may be provided inside the armrest body 100, and the upper surface of the armrest body 100 may have an opening.

The flat surface 201 may be provided on at least one of the outer surfaces of the lid assembly 200 that are configured to come into contact with (e.g., contact, touch, rest on, be received within, etc.) the upper surface of the armrest body 100. The flat surface 201 may be used to dispose the flat surface 201 on the upper surface of the armrest body 100, such that the armrest may be used as a table.

The lid assembly 200 may include a hinge assembly (also referred to as a hinge, a hinge coupler or a hinge coupling part) 210 coupled to one side of the armrest body 100, and a lid (also referred to as a rotating lid or a rotation part) 220 having the flat surface 201 and installed to be rotatable about a second imaginary axis 130 disposed in a direction perpendicular to a first imaginary axis 120, which is the axis of rotation of the hinge assembly 210. The hinge assembly 210 may couple the lid 220 to the armrest body 100 (e.g., one side of the armrest body 100). The lid 220 may have dimensions (e.g., a width, a length, a depth, etc.) that fit the opening of the armrest body 110.

The hinge assembly 210 may be coupled to a short side of the armrest body 100 (e.g., the side of the armrest body 100 closest to the rear of the vehicle) having a rectangular shape, and the hinge assembly 210 may be configured to rotate (e.g., rotate the lid 220) upward to open the upper surface of the armrest body 100 with respect to the opening. The hinge assembly 210 may include a hinge body and a couple of brackets. The brackets may be rotatably attached to the brackets. The brackets may be attached to each side of the hinge body, such that the hinge body may rotate around the first axis of rotation 120. The brackets may be affixed to armrest body 100, thereby attaching the hinge assembly 210 (and the rest of the lid assembly 200) to the armrest body 100.

As described above, the lid 220 may be coupled to be rotatable about the second imaginary axis 130 perpendicular to the first imaginary axis 120, which is the axis of rotation of the hinge assembly 210, such that the flat surface 201 may be selectively disposed as an upper surface of the lid assembly 200, and the armrest may be used as the table.

In addition, a cushion member may be provided on the other side surface opposite to one side surface of the lid assembly 200 on which the flat surface 201 is formed, such that the vehicle occupant may place his/her arm on the armrest and effectively feel comfortable.

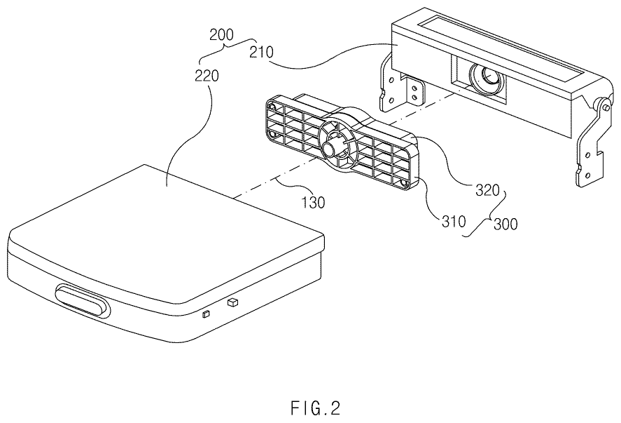

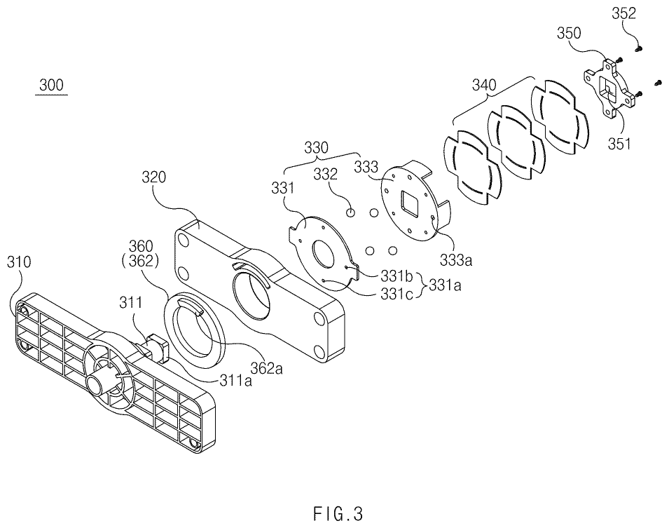

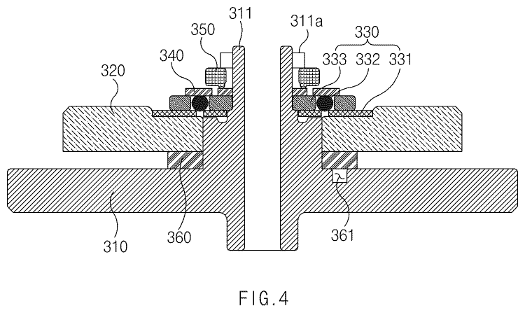

FIG. 2 is an exploded perspective view illustrating a disassembled structure of an example armrest. FIG. 3 is an exploded perspective view illustrating a disassembled structure of a coupler of an example armrest. FIG. 4 is a longitudinal sectional view illustrating a structure of the coupler of an example armrest. As illustrated in FIGS. 2 to 4, a separate coupler (also referred to as a coupling module) 300 may be provided between the hinge assembly 210 and the lid 220 and configured to allow the lid 220 to be rotatably coupled to the hinge assembly 210.

The coupler 300 may include a main shaft bracket 310 having one side surface coupled to a plate surface (e.g., a flat surface or a side plane) of the lid 220, the main shaft bracket 310 having a rotation shaft 311 protruding from a center of the main shaft bracket 310, and a base bracket 320 rotatably coupled to the main shaft bracket 310 and coupled to the hinge assembly 210.

The main shaft bracket 310 may be formed in a rectangular plate shape. The rotation shaft 311 protrudes from a center of a plate surface by a predetermined length, such that the plate-shaped member is fixedly coupled to one side of the lid 220 of the lid assembly 200.

A catch (also referred to as a catching member) 311a may be provided at an end of the rotation shaft 311 and has a polygonal or elliptical shape having a width larger than a diameter of the rotation shaft 311. Therefore, if a cap (also referred to as a bracket, an attachment bracket, or a cover) 350 to be described below rotates by a predetermined angle, the plate surface may be caught by the catch 311a, such that the cap 350 and the rotation shaft 311 are coupled.

The base bracket 320 may be rotatably coupled to the main shaft bracket 310 and fixed to one side surface of the hinge assembly 210. As a result, the base bracket 320 may serve to couple the lid 220 to the hinge assembly 210 so that the lid 220 may rotate about the axis 130.

Like the main shaft bracket 310, the base bracket 320 may be also formed in a plate shape and fixedly coupled in a state of being embedded, by a predetermined depth, in a coupling groove 211 recessed in one side plate surface of the hinge assembly 210.

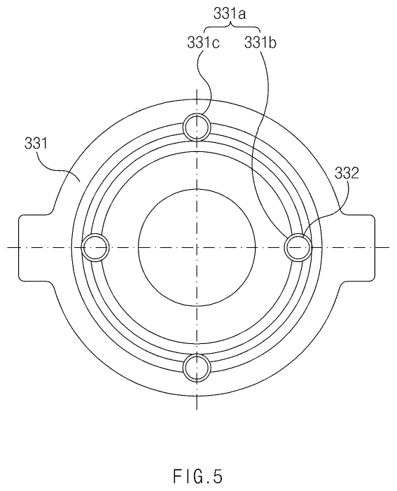

FIG. 5 is a top plan view illustrating a structure of a detent of an example armrest. As illustrated in FIGS. 3 and 5, the armrest may include a detent (also referred to as a rotary detent, a rotational detent, or a position fixing part) 330 configured to fix a position of the main shaft bracket 310 at a predetermined rotational angle (e.g., one of a plurality of rotational angles or positions) when (e.g., after) the main shaft bracket 310 rotates relative to (e.g., with respect to) the base bracket 320.

Because the detent 330 is installed between the base bracket 320 and the hinge assembly 210, the rotation of the lid 220 fixedly coupled to the main shaft bracket 310 may be guided and balanced when the lid 220 rotates relative to the hinge assembly 210, thereby preventing the lid 220 from excessively moving inadvertently.

The detent 330 may include a detent plate (also referred to as a detent disc) 331 positioned rearward of the base bracket 320 (e.g., between the base bracket 320 and the hinge assembly 210) based on a protruding direction of the rotation shaft 311, fixed to the base bracket 320 by being inserted into an outer surface of the rotation shaft 311, and having at least one fixing hole 331a formed through a plate surface thereof, at least one ball (also referred to as detent balls) 332 configured to be repeatedly inserted into the fixing hole 331a or withdrawn from the fixing hole 331a by the rotation of the main shaft bracket 310, and a ball holder (also referred to as a detent plate or a detent disc) 333 fixedly coupled to the outer surface of the rotation shaft 311 and configured to hold the at least one ball 332 to fix a position of the at least one ball 332. The at least one ball 332 may have a diameter that is greater than the diameter of the fixing holes 331a such that the at least one ball 332 would not pass through any of the fixing holes 331a.

As illustrated in FIG. 5, the detent plate 331 may be fixedly disposed (e.g., affixed) by being tightly attached to a plate surface of a rear side of the base bracket 320, and the fixing holes (also referred to as detent holes or stop holes) 331a may be formed through the plate surface of the detent plate 331. The fixing holes 331a may be disposed at positions that define 90° therebetween (e.g., at 90° rotational intervals).

The fixing holes 331a formed in the detent plate 331 may include first fixing holes 331b formed on relatively long radii (e.g., at a first distance from the center of the detent plate 331 or from the second axis of rotation 130), and second fixing holes 331c formed on relatively short radii (e.g., at a second distance from the center of the detent plate 331 or from the second axis of rotation 130, where the first distance is greater than the second distance).

The fixing holes 331a include the first and second fixing holes 331b and 331c having different radii, such that the four balls 332 are selectively inserted into the first fixing holes 331b and the second fixing holes 331c or withdrawn from the first fixing holes 331b and the second fixing holes 331c. The number of the balls 332 may be more than or fewer than four. Only in case that the lid 220 accurately rotates by 180° relative to the hinge assembly 210, all the four balls 332 generate a clicking sound while being inserted into the first fixing holes 331b and the second fixing holes 331c. Therefore, a user may recognize that the rotation of the lid assembly 200 is accurately completed.

In addition, if the lid 220 completely rotates by 180°, all the four balls 332 may be inserted into the fixing holes 331a, which may minimize an inadvertent movement of the lid 220 relative to the hinge assembly 210.

The number of balls 332 may be, for example, four so as to correspond to the number of fixing holes 331a so that the balls 332 are inserted into all the fixing holes 331a or withdrawn from the fixing holes 331a by the rotation of the main shaft bracket 310.

A surface of the ball 332 may be formed in a smooth spherical surface shape, such that the ball 332 may be softly inserted and withdrawn repeatedly if the ball 332 is inserted into the fixing hole 331a or withdrawn from the fixing hole 331a.

In addition, among the balls 332, two pairs of balls 332 may be provided to correspond to each other while having different distances from the rotational axis 130 so that the two pairs of balls 332 may be simultaneously inserted into or withdrawn from the first fixing holes 331b and the second fixing holes 331c. The balls 332 may be initially disposed at positions corresponding to each other at 180°.

The ball holder 333 may be fixedly coupled to the outer surface of the rotation shaft 311 and configured to hold the balls 332 to fix the positions of the balls 332. Insertion holes (also referred to as ball receptacles or detent ball receptacles) 333a into which the balls 332 are inserted may be recessed in a plate surface of the ball holder 333. A depth of the insertion hole 333a may be relatively larger than a depth of the fixing hole 331a formed in the detent plate 331, which may prevent the ball 332 from being arbitrarily withdrawn from the insertion hole 333a.

As illustrated in FIGS. 4 and 5, at least one spring (e.g., at least one flat spring, such as one or more leaf springs) 340 may be installed rearward of the ball holder 333 based on the protruding direction of the rotation shaft 311 in order to press (e.g., exert a pressure on) the ball holder 333 against the detent plate 331.

The at least one spring 340 may be one or more flat springs configured as three members disposed to overlap one another to increase a pressing force (e.g., exert a greater pressure) in order to generate a clearer clicking sound and improve locking properties after the balls 332 are inserted into the fixing holes 331a or withdrawn from the fixing holes 331a formed in the detent plate 331.

The armrest may include the cap 350 disposed rearward of the at least one spring (e.g., at least one flat spring) 340 based on the protruding direction of the rotation shaft 311 and coupled to the ball holder 333 in order to maintain a state in which the at least one spring (e.g., at least one flat spring) 340 presses against the ball holder 333.

A fastening hole 351 may be penetratively formed at (e.g., formed through) a center of the cap 350 and has a cross-sectional shape identical to (e.g., has a matching cross-sectional shape as) a cross-section of the catch 311a provided at the end of the rotation shaft 311. Therefore, if the cap 350 is rotated by a predetermined angle after the catch 311a passes through the fastening hole 351, the cap 350 may be caught by the catch member 311a, such that the rotation shaft 311 and the cap 350 are coupled.

To increase a coupling force between the cap 350 and the ball holder 333, separate fastening bolts 352 may be fastened to four points on the cap 350, such that the cap 350 and the ball holder 333 are fixed to each other.

A stopper (also referred to as a rotary stopper, a catch, a limiter, a bump, a rotation angle restriction means, etc.) 360 capable of restricting an angle by which the main shaft bracket 310 rotates (e.g., restrict a maximum rotational angle of the main shaft bracket 310) relative to the base bracket 320 may be further provided, such that the lid 220 may effectively and accurately rotate by 180° relative to the hinge assembly 210.

The stopper 360 may include an arc-shaped stopper groove 361 recessed in the main shaft bracket 310 and having a predetermined length, and a stopper body (also referred to as a stopper member) 362 interposed between the main shaft bracket 310 and the base bracket 320, having one side surface fixed to the base bracket 320, and having a stopper protrusion (also referred to as a bump or a catch) 362a protruding from the other side surface of the stopper body 362 and inserted into the stopper groove 361.

The stopper groove 361 may be formed in an arc shape having a length longer than the length of the stopper protrusion 362a based on 180°, such that inner surfaces of two opposite sides of the stopper groove 361 come into contact with the stopper protrusion 362a when the lid 220 rotates by 180° relative to the hinge assembly 210.

A through-hole may be penetratively formed at (e.g., formed through) a center of the stopper body 362, and the stopper body 362 may be an annular member into which the outer surface of the rotation shaft 311 is inserted. The stopper protrusion 362a may protrude from one side of the plate surface of the stopper body 362 and may be inserted into the stopper groove 361.

The stopper protrusion 362a may be curvedly formed to have the same curvature as the stopper groove 361 so that the stopper protrusion 362a may be inserted into the stopper groove 361. The stopper protrusion 362a may protrude by a height relatively smaller than a depth of the stopper groove 361 so that the stopper protrusion 362a is inserted into the stopper groove 361.

A plate surface opposite to the plate surface from which the stopper protrusion 362a protrudes may be fixedly coupled to the base bracket 320, such that the rotational angle of the lid 220 is restricted by the stopper 360.

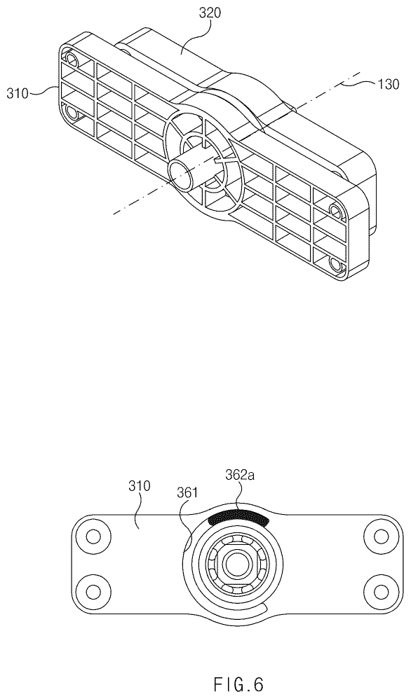

A process of operating the armrest according to the present disclosure configured as described above will be described below with reference to FIGS. 6 to 8.

FIGS. 6 to 8 are operational views sequentially illustrating a process of restricting a rotational angle by a stopper when the coupler of an example armrest rotates. As illustrated in FIG. 6, at the initial position of the lid 220 with respect to the hinge assembly 210, the stopper protrusion 362a may be in contact with the inner surface of one end of the stopper groove 361 formed in the main shaft bracket 310, and the main shaft bracket 310 and the base bracket 320 overlap each other and are disposed parallelly.

In this state, the plate surface having the cushion member of the lid assembly 200 may be directed upward and disposed on the upper surface with the opening of the armrest body 100 of the armrest according to the present disclosure.

At the initial position, the four balls 322 may be respectively inserted into the four fixing holes 331a formed in the detent plate 331.

In order to use the armrest according to the present disclosure as the table, the upper surface of the armrest body 100 may be opened by rotating upward, by a predetermined angle, the lid assembly 200 coupled to one side of the armrest body 100 by the hinge assembly 210.

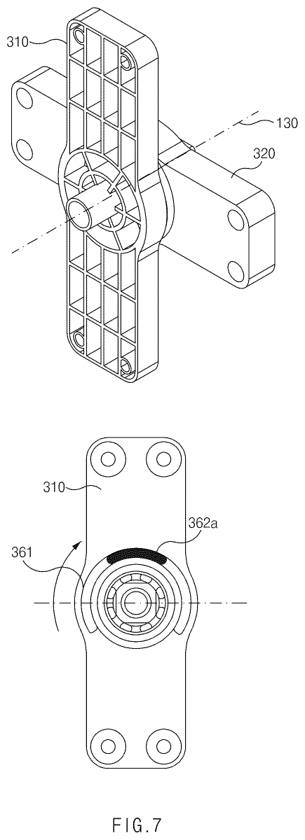

If the lid assembly 200 is rotated by 90°, the lid 220 may be rotated by 90° relative to the hinge assembly 210, as illustrated in FIG. 7. In this state, the stopper protrusion 362a may be in contact with the inner surface positioned at the center of the stopper groove 361 formed in the main shaft bracket 310, and the main shaft bracket 310 and the base bracket 320 may be disposed perpendicularly to each other.

In this state, the lid assembly 200 may be disposed to be perpendicular to or twisted with respect to the upper surface with the opening of the armrest body 100, and the four balls 322 may be withdrawn from the four fixing holes 331a formed in the detent plate 331, such that the four balls 322 are pressed against the plate surface of the detent plate 331 by the flat spring 340.

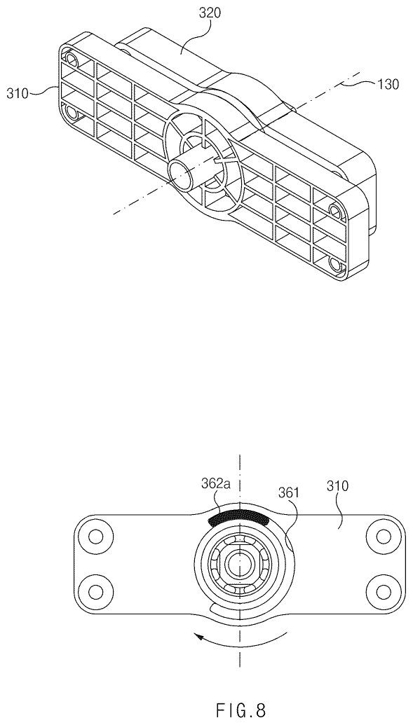

As illustrated in FIG. 8, at the position at which the lid 220 is rotated by 180° relative to the hinge assembly 210, the stopper protrusion 362a may be in contact with the inner surface of the other end of the stopper groove 361 formed in the main shaft bracket 310, such that the lid 220 does not rotate any further. In this case, the main shaft bracket 310 may be rotated by 180°, such that the main shaft bracket 310 and the base bracket 320 overlap each other again and are disposed parallelly.

In this state, the state in which the flat surface 201 of the lid assembly 200 may be directed upward and disposed on the upper surface with the opening of the armrest body 100 may be maintained, such that the armrest according to the present disclosure may be used as the table.

If (e.g., at the moment when) the lid 220 is completely rotated by 180°, the four balls 322 may generate a clicking sound while being inserted again into the four fixing holes 331a formed in the detent plate 331, such that the user may recognize that the rotation of the lid assembly 200 is completed.

In order to achieve the above-mentioned object of the present disclosure, an armrest includes: an armrest body having therein an accommodation space, having an upper surface with an opening, and installed in a vehicle; and an armrest cover having a flat surface provided on at least one of outer surfaces configured to come into contact with the upper surface of the armrest body, the armrest cover being configured to be seated on the upper surface of the armrest body with the opening in a state in which the flat surface is directed toward an upper portion of the armrest body.

In this case, the armrest cover may include: a hinge coupling part hingedly coupled to one side of the armrest body; and a rotation part having the flat surface and installed to be rotatable about a second imaginary axis disposed in a direction perpendicular to a first imaginary axis that is a rotation center of the hinge coupling part.

Further, a separate coupling module may be provided between the hinge coupling part and the rotation part and configured to allow the rotation part to be rotatably coupled to the hinge coupling part.

In addition, the coupling module may include: a main shaft bracket having one side surface coupled to a plate surface of the rotation part, the main shaft bracket having a rotation shaft protruding from a center of the main shaft bracket; and a base bracket rotatably coupled to the main shaft bracket and coupled to the hinge coupling part.

Further, the armrest may include: a position fixing part configured to fix a position of the main shaft bracket at a predetermined rotation angle when the main shaft bracket rotates relative to the base bracket.

Further, the position fixing part may include: a detent plate positioned rearward of the base bracket, fixed by being inserted into an outer surface of the rotation shaft, and having a plate surface in which a plurality of fixing holes is penetratively formed; a plurality of balls configured to be repeatedly inserted into and withdrawn from the fixing holes by a rotation of the base bracket; and a ball holder on which positions of the balls are fixedly installed, the ball holder being rotatably coupled to the outer surface of the rotation shaft.

In addition, the fixing holes formed in the detent plate may include: a first fixing hole formed on a relatively long radius; and a second fixing hole formed on a relatively short radius, and the balls may be formed to have different distances from a rotation center axis so that the balls are each inserted into or withdrawn from any one of the first fixing hole and the second fixing hole.

Further, a plurality of flat springs may be installed rearward of the ball holder to press the ball holder toward the detent plate, and the armrest may include a cover disposed rearward of the flat spring and coupled to the ball holder to maintain a state in which the flat springs press the ball holder.

Further, a catching member may be provided at an end of the rotation shaft and have a polygonal shape having a width larger than a diameter of the rotation shaft, a fastening hole may be penetratively formed at a center of the cover and have a cross-sectional shape identical to a cross-section of the catching member, and the cover may be caught by the catching member when the cover is rotated by a predetermined angle after the catching member passes through the fastening hole.

In addition, the armrest may further include: a rotation angle restriction means configured to restrict an angle by which the main shaft bracket rotates relative to the base bracket.

Further, the rotation angle restriction means may include: an arc-shaped stopper groove recessed in the main shaft bracket and having a predetermined length; and a stopper member interposed between the main shaft bracket and the base bracket, having one side surface fixed to the base bracket, and having a stopper protrusion protruding from the other side surface of the stopper member and inserted into the stopper groove.

The armrest according to the present disclosure configured as described above may be provided in the vehicle and used as the table in a simple manner, as necessary, thereby improving the convenience and satisfaction for the vehicle occupant.

While one or more example embodiments, which may be implemented by the present disclosure, have been described above, the example embodiments are just illustrative and not intended to limit the present disclosure. It can be appreciated by those skilled in the art that various modifications and applications, which are not described above, may be made to one or more example embodiments without departing from the intrinsic features of those example embodiments. For example, the respective constituent elements specifically described in one or more example embodiments may be modified and then carried out. Further, it should be interpreted that the differences related to the modifications and applications are included in the scope of the present disclosure defined by the appended claims.

What is claimed is:

1. An armrest of a vehicle, the armrest comprising:
an armrest body having therein a storage compartment, wherein the armrest body comprises an upper surface with an opening; and
a lid assembly comprising a flat surface configured to, in a closed position of the lid assembly, contact the upper surface of the armrest body with the flat surface facing an upper portion of the armrest body.

2. The armrest of claim 1, wherein the lid assembly further comprises:
a hinge assembly having a first axis of rotation; and
a lid having the flat surface and installed to be rotatable around a second axis of rotation, wherein the second axis of rotation is perpendicular to the first axis of rotation,
wherein the hinge assembly is configured to couple the lid to one side of the armrest body.

3. The armrest of claim 2, wherein the lid assembly further comprises a coupler configured to rotatably couple the lid to the hinge assembly.

4. The armrest of claim 3, wherein the coupler comprises:
a main shaft bracket having one side surface coupled to a surface of the lid, the main shaft bracket having a rotation shaft protruding from a center of the main shaft bracket; and
a base bracket rotatably coupled to the main shaft bracket and coupled to the hinge assembly.

5. The armrest of claim 4, further comprising:
a detent configured to fix a position of the main shaft bracket at one of a plurality of predetermined rotational angles after the main shaft bracket rotates relative to the base bracket.

6. The armrest of claim 5, wherein the detent comprises:
a detent plate disposed between the base bracket and the hinge assembly and affixed to the rotation shaft, wherein a plurality of detent holes are formed on a surface of the detent plate;
a plurality of detent balls configured to be repeatedly inserted into and withdrawn from the plurality of detent holes based on a rotation of the base bracket; and
a ball holder on which the plurality of detent balls are installed at fixed positions, wherein the ball holder is rotatably coupled to the rotation shaft.

7. The armrest of claim 6, wherein the plurality of detent holes formed on the surface of the detent plate comprise:
one or more first detent holes formed at a first distance from the second axis of rotation; and
one or more second detent holes formed at a second distance from the second axis of rotation, the second distance being less than the first distance, and
wherein the plurality of detent balls are disposed at different distances from the second axis of rotation such that the plurality of detent balls are each inserted into or withdrawn from any one of the one or more first detent holes or the one or more second detent holes.

8. The armrest of claim 6, further comprising at least one spring configured to exert a pressure on the ball holder against the detent plate; and
a cap disposed between the at least one spring and the hinge assembly, and wherein the cap is coupled to the ball holder to maintain the pressure exerted by the at least one spring on the ball holder,
wherein the at least one spring is disposed between the ball holder and the cap.

9. The armrest of claim 8, wherein the rotation shaft comprises a catch at an end of the rotation shaft, wherein the catch has a polygonal shape having a width larger than a diameter of the rotation shaft,
wherein a fastening hole is formed through the cap at a center of the cap, wherein the fastening hole has a matching cross-sectional shape as the catch, and
wherein the cap is configured to be caught by the catch based on the cap rotating by a predetermined angle after the catch passes through the fastening hole.

10. The armrest of claim 4, further comprising:
a stopper configured to restrict a maximum rotational angle of the main shaft bracket relative to the base bracket.

11. The armrest of claim 10, wherein a stopper groove is recessed on the main shaft bracket, the stopper groove being arc-shaped and having a predetermined length, and
wherein the stopper is disposed between the main shaft bracket and the base bracket, wherein a first surface of the stopper is affixed to the base bracket, wherein the stopper comprises a stopper protrusion that protrudes from a second surface of the stopper and is inserted into the stopper groove, and wherein the second surface is on an opposing side, with respect to the first surface, of the stopper.

12. An armrest comprising:
an armrest body, wherein a top surface has an opening to a storage compartment formed inside the armrest body;
a lid assembly comprising:
a lid having dimensions that fit the opening of the armrest body;
a hinge assembly configured to attach the lid assembly to the top surface of the armrest body such that the lid is rotatable, between a closed position of the lid and an open position of the lid, around a first axis of rotation of the hinge assembly; and
a coupler that connects the hinge assembly to the lid.

13. The armrest of claim 12, wherein the coupler comprises:
a first bracket, wherein a through-hole is formed through the first bracket;
a second bracket coupled to the lid and comprising a shaft protruding orthogonally from a surface of the second bracket, wherein the shaft of the second bracket is inserted into the through-hole of the first bracket such that the second bracket is rotatable around a second axis of rotation that coincides with a cylindrical axis of the shaft; and
a rotary detent.

14. The armrest of claim 13, wherein the rotary detent comprises:
a first detent disc coupled to the first bracket, wherein a plurality of detent holes, having a first diameter, are formed on the first detent disc;
a second detent disc coupled to the hinge assembly, wherein a plurality of detent ball receptacles are formed on the second detent disc; and
a plurality of detent balls having a second diameter greater than the first diameter, wherein each of the plurality of detent balls is inserted into a corresponding detent ball receptacle of the plurality of detent ball receptacles of the second detent disc, wherein, based on the first detent disc rotating around the second axis of rotation relative to the second detent disc, each of the plurality of detent balls is inserted into or withdrawn from one or more detent holes of the plurality of detent holes of the first detent disc, and
wherein the rotary detent is coupled to the shaft of the first bracket such that the first bracket is disposed between the second bracket and the rotary detent.

15. The armrest of claim 13, further comprising:
a stopper disposed between the first bracket and the second bracket and configured to restrict a maximum rotational angle of the second bracket relative to the first bracket.

16. The armrest of claim 14, wherein the rotary detent further comprises:
a cap coupled to the second detent disc; and
one or more springs disposed between the second detent disc and the cap, wherein the one or more springs are configured to exert a pressure on the second detent disc to push against the plurality of detent balls and the first detent disc.
